(19) United States
(12) Patent Application Publication
(10) Pub. No.: US 2023/0081997 A1
(43) Pub. Date: Mar. 16, 2023

(54) UNIT DOSES FOR RELEASING AN AQUEOUS FORMULATION

(71) Applicant: MELCHIOR MATERIAL AND LIFE SCIENCE FRANCE, LACQ (FR)

(72) Inventors: Olivier GUERRET, PERN (FR); Brice COURDESSES, PARNAC (FR)

(73) Assignee: MELCHIOR MATERIAL AND LIFE SCIENCE FRANCE, LACQ (FR)

(21) Appl. No.: 17/799,182

(22) PCT Filed: Feb. 24, 2021
(86) PCT No.: PCT/FR2021/050320

§ 371 Date: Aug. 11, 2022

(30) Foreign Application Priority Data
Feb. 27, 2020 (FR) FR2001964

(51) Int. Cl. B65D 65/46; C08L 67/04; F42B 12/76

(52) U.S. Cl. CPC B65D 65/466; C08L 67/04; F42B 12/76; C08L 2201/06

(57) ABSTRACT

The invention relates to biodegradable unit doses intended to contain, store, preserve, transport and dispense an aqueous formulation. The doses comprise a shell containing the aqueous formulation, which is made of a material comprising a mixture of biodegradable polymers A and B, such that: —biodegradable polymer A is a thermoplastic polymer having a glass transition temperature of less than 0° C. and —the biodegradable polymer B is a thermoplastic polymer having a glass transition temperature greater than 50° C., characterised in that the unit dose is spherically shaped comprising two poles and an equatorial area, —the equatorial area corresponding to a junction of the two hemispheres and —the shell having at least one line of circumferential weakness, or even two lines of circumferential weakness, located between the equatorial area and one or both poles.

The use of plastic materials in outdoor applications leads to the accumulation of very long-lasting debris. Plastic bags and bottles must be: either industrially recyclable (which involves a whole collection and recycling logistics); or biodegradable, preferably under natural composting conditions.

Plastic materials can also be hidden in liquid formulations: for example, a paint called oil paint is generally composed of polymers that are liquid at room temperature such as polyethylene glycol, waxes, polyesters or polyurethanes or crosslinkable monomers or solvents such as glycol or propylene glycol. The fact remains that once the paint dries, the polymer molecules accumulate and can constitute invisible pollution but have a strong impact on wildlife and the environment because of the microparticles they generate.

For example, the paintballs commonly used for the “paintball” game consist of a gelatin shell that is perfectly biodegradable but which, to remain intact, must contain a filler such as a perfectly hydrophobic paint, therefore based on liquid polymers. A disadvantage of these balls is their stability in contact with the atmosphere since the humidity of the air softens their shell and causes risks of explosions of the ball in the propellants.

Furthermore, their behavior during storage and transport is problematic due to softening and embrittlement of the shell. Balls can stick together and block the propellants. Other weakened ones can explode in the propellant.

The problem of replacing a hydrophobic filler formulation such as an oil paint with an aqueous formulation based on water and pigments has been addressed in other inventions. The principle consisted in replacing the gelatin shell with a polymer shell. Examples include polystyrene (EP0609298) polypropylene or polyethylene (EP2490945). Balls made with these polymers are waterproof and can therefore contain aqueous formulations, but shell residues remain an important environmental issue. It should be noted that in these patents, the authors provide for the possibility of incorporating biodegradable polymers without evaluating the difficulty of making them: their main invention consisting in the method for assembling two hemispheres by fusion or bonding. To our knowledge, none of these methods have been developed industrially to date.

A second attempt to circumvent this problem is found in U.S. Pat. No. 5,448,951, where the authors hope to produce paintballs by a method of injection molding of a biodegradable starch-based material. This type of method would theoretically lead to balls of constant thickness. However, no industrial application of this method has been implemented, probably due to the complexity of filling already formed balls. The stability of the balls in storage is also similar to that of gelatin balls since the starch, a hydrophilic material, can absorb some of the humidity in the air.

A second attempt to manufacture paintballs made of a biodegradable material is described in US2006/0005732A1 via a blowing/molding method, but the difficulty of filling spherical objects did not allow industrial development of the technology.

A final way of circumventing the problem has been described in U.S. Pat. No. 8,342,099, WO2014/016510A1, FR2921475A1 and FR2993864A1 and FR3018268A1 using shells made of oxodegradable polymer via a heat-welding method of 2 pre-filled half-spheres. However, these solutions are not satisfactory for 3 reasons: 1) oxodegradable polymers disintegrate well under the action of light and oxygen but they result in long-lived microparticles, dangerous for the environment; 2) when the polymer is used for the manufacture of balls, it comes into contact with air and light and its degradation process begins. After a few months of storage, these balls can become fragile enough that they explode in the propellant; 3) the manufacturing method described in FR3018268A1 generates approximately 40% plastic waste due to the cutting of shapes in the starting film. However, these scraps having started their degradation process, they are not recyclable in a new plastic material.

In addition, from an environmental point of view, the fact that oxodegradable polymers contain transition metals makes the ultimate residues of these polymers very harmful in the long term.

Finally, to complete the presentation of the context of the invention, it should be recalled that the patent FR3018268A1 describes the principle of a machine whose operation consists first of all of passing a polymer film through a thermoforming machine to create impressions of hemispheres and then to cut this film into parallel strips to supply ball production modules. In reality, the production module is organized around a turntable which performs the following tasks:
Two strips of hemispheres feed the first station which will position 4 hemispheres in circular holes positioned in a square.
The 4 hemispheres are then filled with the paint formulation via supply nozzles connected to a main manifold.
The 2 outermost hemispheres are then returned onto the 2 inner ones using suction cups mounted on articulated arms.
The first ball undergoes ultrasonic welding and the pressure simultaneously exerted on the circumference cuts the circumference and frees the ball from the skeleton of the polymer film.
The second ball undergoes the same process.
each ball is expelled towards a collector

The inventors have observed that the yield of balls correctly sealed according to this method does not exceed 50%. When the formulation has a low cost such as a water-based paint, this may be tolerable, but when the formulation contains micro-encapsulated active ingredients with high added value, this extinguishes any possibility of industrial development.

Indeed, in certain embodiments or applications, the balls represent a unit dose form, among others, intended to store, transport as well as dispense or even release one or more active pharmaceutical or phytopharmaceutical ingredients at a given point, for example.

Indeed, when it comes to a unit dose, it is, as for the pharmaceutical field when it comes to galenic form, of a composition comprising a shell, protecting a formulation vis-A-vis the outside, containing a predetermined amount of said formulation, with or without active ingredient, and intended to be dispensed at a given point and at a desired time.

Such unit dose forms must thus preserve the internal formulation, whether it is a paint or a formulation comprising an active ingredient. The constitution of these unit dose forms must allow their handling, storage and transport while preserving the formulation thus contained while allowing easy or controlled dispensing and release of the contained formulation at the desired time and place.

The unit dose forms can effectively be spherical as seen for paintballs. This being the case, such a spherical shape, if it has advantages because it can be used in a pneumatic propulsion device, is not limiting. Indeed, it is just as well possible to consider unit doses of varied shape and geometry, hemispherical or cylindrical, for example. The shape will be dictated by the manufacturing method which may be of the type used for paintballs as mentioned above, but also by the application: a projectile will benefit from being spherical but other shapes may be used if the shells are intended to be pierced or torn in an ad hoc device. For example, a unit dose can also be in the shape of a cylinder filled with an adapted formulation and crimped by welding at both ends, for example.

Patent FR3018268A1 describes a step of thermoforming from a film then a step of filling, welding and cutting the shell of the balls.

The inventors have observed that the balls obtained according to the FR 3018268A1 method had poor ballistics.

It was therefore necessary to find a new shell material as well as a geometry or conformation in order to obtain biodegradable balls of good quality, not exploding in the barrel and having suitable ballistics while allowing yields authorizing industrial development.

### BRIEF DESCRIPTION OF THE INVENTION

In order to overcome all these problems, the applicant has found that it was possible to use a new biodegradable material for the manufacture of unit dose forms intended to contain, store, preserve, transport and dispense an aqueous formulation; this is the first object of the invention. In addition to its biodegradable nature, this material is characterized by an elastic behavior to withstand storage temperatures close to 0° C. without the unit doses breaking, and by a fragile behavior so that the unit doses can easily break during implementation, at room temperature, in order to release the formulation contained. Thus, they can explode upon contact with the support on which they are projected via a pneumatic propellant device, for example, at ambient temperature. Alternatively, as the material is biodegradable, a unit dose according to the invention can be placed in a desired location, in the air and in the light. The shell will decompose and release the filling formulation which may contain an active ingredient which will therefore be released, in particular according to controlled diffusion kinetics, according to the composition of the formulation. In addition, the unit dose can also be handled by a user who can break the shell, by crushing or tearing, at the desired time, to release the filling formulation.

The material of the shell of the unit doses of the invention therefore contains a biodegradable polymer having a glass transition temperature of less than 0° C. and a biodegradable thermoplastic polymer with a high glass transition temperature, having a fragile nature. The material of the shell can also comprise a mineral filler and additives allowing easy implementation.

Surprisingly, in the case of spherical unit doses, balls for example, the invention allows to overcome the problems of poor welding and fragility in storage of the balls obtained according to a method of the prior art such as that described in FR3018268A1. This discovery allows to improve the yield of balls that are stable in storage and have good ballistics.

### DETAILED DESCRIPTION OF THE INVENTION

For the purpose of a good reading of the description of the invention, it is important to first recall the following definitions:
Biodegradable polymer sequence of monomers derived from biomass or not which can be degraded by composting. There are two types of composting: industrial composting where the temperature is artificially maintained at more than 50° C. and where the microorganisms are selected for their activity of degradation of the targeted polymer and natural composting.
Pole: if it is considered that the welding of the balls or spheres corresponds to the equator, a pole is defined for the ball or sphere as for the earth.
Compound: this term designates, in the technical language of the person skilled in the art, a physical mixture of polymers, fillers and additives. The compounds are generally obtained in the form of granules by hot mixing of all the components followed by extrusion and granulation.
Active ingredient: active molecule such as a pheromone, a perfume or an insecticide, for example contained in the aqueous formulation and which can be encapsulated. The encapsulation can be carried out in microcapsules such as, for example, those described in U.S. Pat. No. 8,524,260, US2010/278925A1, WO2009/007810A1, WO2014/096622A1, U.S. Pat. No. 6,248,364B1, WO2012/095444A2, WO99/56541.
Unit dose: in the context of the present invention, this expression refers to a solid or semi-solid unitary object formed of a shell containing a specific predetermined amount of a more or less fluid or liquid aqueous formulation, said formulation possibly containing at least one active ingredient, optionally encapsulated. Said formulation can also be a paint in aqueous phase.

The present invention thus relates, according to a first embodiment, to a unit dose for storing, transporting, dispensing or releasing an aqueous formulation, said unit dose comprising a shell containing said aqueous formulation, said shell comprises a material comprising a mixture of two biodegradable polymers A and B, such that:
the biodegradable polymer A is a thermoplastic polymer having a glass transition temperature of less than 0° C. and
the biodegradable polymer B is a thermoplastic polymer having a glass transition temperature greater than 50° C.,
   characterized in that said unit dose is spherically shaped comprising two poles and an equatorial area,
the equatorial area corresponding to a weld of two hemispheres and
the shell has at least one line of circumferential weakness, or even particularly two lines of circumferential weakness, located between the equatorial area and one or both poles.

The shell of the unit dose of the invention thus comprises one line of circumferential weakness located between the equatorial area and one of the poles.

Advantageously, the shell of the unit dose according to the invention comprises two lines of circumferential weakness, each located between the equatorial area and one of the poles.

According to one embodiment, the shell may comprise more than two lines of circumferential weakness and these lines of weakness are located between the equatorial area and one of the poles or else between the equatorial area and the two poles. Thus, a spherically shaped dose hemisphere may comprise one or more lines of circumferential weakness located as described above. Advantageously, the two hemispheres can each comprise one or more lines of circumferential weakness.

According to a second embodiment, the invention relates to a unit dose characterized in that:
polymer A is selected from the group comprising polycaprolactone, succinate polyesters, adipic acid polyesters, copolymers thereof and mixtures thereof;
polymer B is selected from the group comprising polylactides.

According to another embodiment of the invention, the succinate polyester is selected from the group comprising poly(butylene adipate), poly(butylene succinate), copoly(butylene succinate adipate) and mixtures thereof.

In one embodiment of the invention, the unit dose according to the invention is characterized in that:
The amount of polymer A is comprised, in % by weight of the shell, between 50 and 95%, particularly between 60 and 95%, more particularly between 70 and 95%;
The amount of polymer B is comprised, in % by weight of the shell, between 5 and 50%, particularly between 5 and 30%, more particularly still between 5 and 20%.

A method for evaluating the mechanical properties of materials consists in studying their reaction in rheometers which measure the complex Coulomb modulus whose real component G′ corresponds to the elastic behavior while its imaginary component G″ corresponds to the viscous component of the modulus.

According to a particular embodiment, the elastic modulus G′, at a frequency of 1 Hz and at an imposed deformation of 0.1%, and at 40° C. of the material is less than 100 MPa, particularly less than 70 MPa, less than 50 MPa, particularly less than MPa, particularly still less than 20 MPa, or even less than 10 MPa.

The modulus G′ of the shell material can thus be comprised between 5 and 100 MPa, between 10 and 90 MPa, even between 20 and 70 MPa, or even between and 65 MPa.

In one embodiment, the invention also aims at a unit dose as defined above, characterized in that the shell comprises a mineral filler in an amount comprised between 0 and 10% by weight of the shell.

The mineral filler comprises substances generally of natural origin, insoluble in the aqueous formulation of the unit dose of the invention. This mineral filler can be selected from the group consisting of (natural or precipitated) calcium carbonates and/or magnesium carbonates, barium sulphate, silicas, silicates, alumino silicates such as talc or kaolin and mixtures thereof.

The present description describes a unit dose according to one of the preceding embodiments, characterized in that it is in a spherical, hemispherical, cylindrical, semicylindrical, conical, frustoconical, oblong, cubic, parallelepiped or ovoid shape.

The dose according to the invention is particularly suitable for use in a propulsion device of the type paintball pistol or gun or slingshot.

In the context of playful application, the spherical unit dose, similar to a paintball, contains an aqueous formulation of the water-based paint type commonly used in such applications.

Alternatively, the aqueous formulation contained in the unit dose according to the invention can be a formulation containing an active ingredient, in particular an encapsulated active ingredient.

According to a particular embodiment, the aqueous formulation contained in the unit dose according to the invention can be an aqueous paint formulation. As an aqueous paint formulation, mention may be made of latex-free aqueous paint formulations comprising a thickener of natural or synthetic origin, combined with a mineral filler and a pigment. A natural thickener can be selected from the group consisting of cellulose derivatives, gums, gelatin and mixtures thereof. In particular, it may be hydroxycellulose or its derivatives, guar gum, gum arabic, edible gelatin, or mixtures thereof. A synthetic thickener can be selected from the group consisting of swellable emulsions in an alkaline medium (alkali swellable emulsion, or ASE and HASE) or urethane thickeners of the HEUR type (for hydrophobic ethoxylated urethanes).

The invention also relates to a unit dose according to one of the preceding embodiments, characterized in that the shell has at least one line of weakness.

As explained, the invention relates to a unit dose according to one of the preceding embodiments, characterized in that:
it is spherically shaped comprising two poles and an equatorial area,
the equatorial area corresponding to a weld of two hemispheres and
the shell has at least one line of circumferential weakness, or even particularly two lines of circumferential weakness, located between the equatorial area and one or both poles.

Advantageously, each line of circumferential weakness comprises, or consists of, a reduction in the thickness of the shell.

A line of weakness, in the context of the present invention, is an area of the shell of the unit dose of the invention which has a structural weakness and which thus determines an area of predetermined rupture when subjected to mechanical stress.

Such mechanical stress can be an impact when the unit dose is propelled at high speed using a pneumatic propulsion device such as a paintball gun.

A mechanical stress can also be pressure with a finger or other blunt or pointed object, or even an adapted tool, leading to the rupture of the shell and the release of the aqueous release.

A line of weakness can be a reduction in the thickness of the shell, a continuous or discontinuous grooving on the inner or outer surface of the shell. Such a grooving can be peripheral or on a single face of the unit dose. A line of weakness can also be one or more areas of weakness assuming that the shell maintains its integrity for the preservation of the aqueous formulation during transport and storage, but has a localized propensity to tear under mechanical stress.

More particularly still, according to the invention, when each line of circumferential weakness comprises, or consists of, a reduction in thickness of the shell of the unit dose according to the invention, the reduction in thickness of the shell is such that the thickness of the shell is of the order of 20 to 60%, in particular 30 to 50%, of that in the equatorial area and of 60 to 80%, in particular 65 to 75%, of that at the poles.

As explained, it is a reduction in thickness of the shell in a circumferential area located at the equator, or equatorial weld area, and each pole.

Typically, the thickness of the shell at the equatorial weld area is comprised between 250 and 1000 μm, particularly between 300 and 800 μm, more particularly still in 400 and 600 μm.

Typically, the thickness of the shell at the poles is comprised between 100 and 600 μm, particularly between 200 and 500 μm, more particularly still in 250 and 350 μm.

According to one embodiment, the shell/aqueous filling formulation mass ratio is comprised between 1/20 and 1/200.

According to a particular embodiment, the invention relates to a unit dose according to one of the preceding embodiments, characterized in that the aqueous formulation comprises an active ingredient selected from semiochemical compounds, insecticidal compounds, fungicidal compounds, odorous molecules and mixtures thereof. Conceming the odorous molecules, they may be odorous molecules for olfactory marking of the animal pheromones type.

Advantageously, the unit dose according to the invention is characterized in that the semiochemical active ingredient is selected from insect or mammalian pheromones, in particular insect pheromones. Advantageously, the pheromone is selected from the group of fatty chain insect pheromones, in particular a sex pheromone of pine processionary butterflies, oak processionary butterflies, box tree moths, bombyx and codling moths.

The viscosity of the formulation is selected so that the formulation is sufficiently fluid to be dosed in the hemispheres and sufficiently elastic so that the hemispheres can be turned over on each other without pouring the formulation.

In particular, the aqueous formulation of a unit dose according to the invention is of the “oil-in-water” emulsion type in which the aqueous phase comprises a gelling agent and the fatty phase comprises a matrix consisting of a mixture of oil and/or wax and active ingredient, in particular a pheromone.

Such a formulation is described in detail in application EP3352568.

In particular, the oil and/or wax/active ingredient, in particular a pheromone, mass ratio in the fatty phase is comprised between 70/30 and 99.5/0.5, more particularly between 80/20 and 98/2.

The filling of the unit doses according to the invention comprises, or consists of, an aqueous formulation which allows to slowly release the active ingredient(s), in particular the pheromone(s). This aqueous formulation comprises, or consists of, an emulsion of the oil-in-water type which comprises from 20 to 70% by weight of aqueous phase and from 80 to 30% by weight of a dispersed fatty phase comprising, or consisting of, a matrix based on natural wax and/or biodegradable natural oil in which is incorporated the active ingredient(s), in particular pheromones intended to control the behavior of pests, such as insects.

The stability of the emulsion of the aqueous phase is ensured by the presence of a water-soluble gelling agent, or rheology modifying agent. The gelling agent, or rheology modifying agent, contributes to increasing the viscosity of the aqueous filling phase so that the latter does not scatter when the projectile bursts during impact. The nature of the water-soluble gelling agent is not critical in itself as long as it is compatible with the desired viscosity and with the active ingredient, in particular the pheromone, contained in the fatty phase. The water-soluble gelling agent or rheology modifying agent can be selected from polysaccharides or else from the group comprising cellulose ethers, polyurethanes or copolymers of the HASE type.

As cellulose ether, mention may be made of methyl cellulose, hydroxymethyl cellulose, hydroxyethyl cellulose, hydroxypropyl cellulose, hydroxyethyl methyl cellulose, hydroxypropyl methyl cellulose and carboxymethyl cellulose.

It is recalled that polymers of the HASE type: (hydrophobically modified alkali swellable emulsion) are (meth)acrylic acid and alkyl acrylate copolymers produced by radical emulsion polymerization which have the property, when neutralized by a base such as soda or ammonia to become water-soluble and to modify the rheology of the water, but whose composition also comprises hydrophobic macromonomers.

Finally, it is also an embodiment of the present invention to provide a use of a unit dose according to one of the preceding embodiments, for the protection of a plot against a pest comprising the supply of a unit dose according to the invention in which the aqueous fluid comprises at least one active compound with regard to said pest and the positioning of the unit dose at a point of the plot in order to ensure the diffusion of the active compound.

The use of a unit dose according to the invention is also characterized in that the diffusion of the active compound is achieved by the biodegradation of the shell of the unit dose.

The use of a unit dose according to the invention is also characterized in that the diffusion of the active compound is carried out by making an opening of the shell of the unit dose simultaneously or prior to its positioning.

Alternatively and also advantageously, the use of a unit dose according to the present invention is characterized in that the diffusion of the active compound is carried out by the projection of the unit dose on a solid support in order to ensure the rupture of the shell of the unit dose. This rupture is obtained due to the high-speed impact of the unit dose on a hard obstacle, for example a tree trunk or a branch.

Also, given the biodegradability of the materials of the shell, a unit dose according to the invention can be disposed at any location of a plot to be protected. Thus, time, oxygen and light producing their effects, the shell will quickly degrade and release the aqueous formulation contained which will be able to release the active ingredient(s) contained, if necessary.

The projection of the unit doses according to the invention allows to create in an agricultural or forest plot, such as a forest or a wooded or cultivated space, as many points of diffusion of an active ingredient, such as a pheromone for example, as impacts achieved. A high density of impacts combined with the controlled release of the active ingredient, such as a pheromone for example, by each diffuser allows to create an active ingredient cloud, in particular a pheromone. The diffusion of the pheromone prevents the insects reproductive cycle from proceeding properly. This disturbance reduces the population of pests and therefore protects trees and crops from the damage they cause.

Surprisingly, the applicant has developed a method allowing to obtain, with high yield, unit doses according to the invention of perfectly sealed spherical shape. This method is characterized by a step of thermoforming the hemispheres to obtain an advantageous distribution of plastic material. The applicant has indeed found that a thickness of the shell in the area located between each pole and the equatorial area of the order of 20 to 60%, in particular 30 to 50%, of the thickness in the equatorial area and of 60 to 80%, in particular 65 to 75%, of the thickness at the pole is particularly advantageous. Thus the thickness of the wall of the spheres varies so that the thickness of the equatorial weld area is comprised between 300 and 800 microns, the thickness at the poles is comprised between 40% and 70% of the thickness of said equatorial weld area, and the thickness between the equatorial weld area and the pole, that is to say the circumferential weakness area, is comprised between 20 and 60% of the thickness of the equatorial weld area.

A second step aims at welding the 2 hemispheres according to a welding technique known to the person skilled in the art, for example by anvil and sonotrode as described in the document FR3018268A1.

The rheological properties of the new biodegradable materials of the shell of the unit doses according to the invention allow, during the thermoforming step, to achieve the distribution of material according to the criteria defined above.

In addition, by following this new method, the new material of the invention substantially improves the quality of the weld due to its elastic component which flows as soon as the temperature rises, flows and thus optimizes the contact between the surfaces to be welded.

Moreover, the presence of a polymer with a low glass transition temperature induces a greater resistance to elongation, which allows to cut the ball from the polymer skeleton without risking tearing the weld.

Thanks to all these novelties, the user of paintballs takes less risk of seeing the balls explode in the propellant and will see the pieces of plastic related to the application of the ball in nature degrade naturally.

A final advantage of balls made using this method is the way they burst upon impact. Indeed, the ductile nature of the material prevents an explosion generating mist and allows an almost quantitative deposition of the aqueous formulations on the targeted supports.

In order to better illustrate the invention, the applicant has produced the following examples

### EXAMPLES

Materials:

Active Ingredients Contained in the Aqueous Formulations of Microcapsules:

The active ingredients contained in the paintballs, manufactured according to the method of the invention, are formulated according to the principles of the invention of patent WO2016131883A1.

They are in the form of an aqueous suspension of microparticles containing the active ingredient. The microparticles consist of a solid shell based on an acrylic copolymer, surrounding a core comprising a mixture of oil, wax and active ingredient. The deposition on a support (by explosion of the ball in the canopy of trees for example) of this aqueous suspension of microparticles appears, after evaporation of the water, in the form of a film capable of diffusing, in a controlled manner, the active ingredient, overtime.

Several types of active ingredients have been tested in the context of the present invention:
pheromones which are: either purchased from industrial manufacturers, or manufactured by M2i Development according to known methods. In the case of products synthesized by M2i, their characterizations are validated by a comparative analysis with a reference sample in gas phase chromatography.
biocontrol insecticides or fungicides, which are purchased from industrial manufacturers, for example 15 pinosad, a substance of natural microbial origin authorized in biocontrol, comes from Corteva.
odorous molecules used for olfactory marking.

Biodegradable Polymers Used for the Shell of the Balls:

Supply:

Various mixtures or compounds based on biodegradable polymers have been produced.

The following polymers:
High molecular weight polylactide (PLA)
Polybutylene co(Succinate/Adipate) (PBSA)
Polybutylene succinate (PBS)
   and mixtures thereof were purchased from various manufacturers such as Végéplast®, Natureplast®, Résinex®, in the form of extrudable granules.

Biodegradability of the Mixtures:

The biodegradability, in an industrial composter or naturally, of the basic compounds forming the mixture is certified by the different producers, according to different standards (for example EN 13432) depending on the origin of the products or the locations of the manufacturers concerned.

The biodegradability of the compounds is under study but should naturally result from the biodegradability of the basic compounds even if it is known that it can potentially be modified according to the mixtures made (positively or negatively).

The addition of additives (mineral or vegetable fillers, shaping aids, . . . ) can also vary the average destruction time by biodegradation, in particular by hydrolysis (Floriane Freyermouth. Study and modification of the properties of poly(butylene succinate), a biosourced and biodegradable polyester. Materials. INSA Lyon, 2014. French. NNT: 2014ISAL0009. tel-01135306). But from a chemical point of view, these mixtures of biodegradable polymers, unlike oxodegradable polymers, are not likely to degrade into particles that are dangerous for the environment.

Rheological Analyzes of Polymers:

To guide the choice of mixtures of biodegradable polymers to be used in the method according to the invention, a characterization of their mechanical properties as a function of temperature is carried out by dynamic mechanical analysis (DMA).

The DMA (Dynamic Mechanical Analysis) analysis measurements are carried out on an MCR301 apparatus from Anton Par by the company Canoé@.

A geometry, with parallel planes, with a diameter of 25 mm and a gap of 1 mm, is used to analyze the sample, from the viscous state to the solid state. The sample to be characterized (in solid form) is shaped directly on the system at 220° C.

The polymer cooling DMA curves are obtained by applying, to the sample, an oscillatory dynamic stress at a frequency of 1 Hz, with a temperature ramp of −2° C./min, a frequency of 1 Hz and an imposed deformation of 0.1% (value guaranteeing the linear deformation of the material that is to say the deformation of the material is proportional to the stress). The sample thus stressed is cooled from 200° C. to 30° C.

On the DMA curves obtained, several areas are observed:

1. At high temperatures, a first area characteristic of the molten state which allows to characterize the viscosity of the product at these temperatures, and which is directly related to the processing capacity of the polymer; For each mixture a viscous modulus is deduced from this first part of the curve.

2. An area of increased cohesion then appears, for which the temperature for which the Dahlquist criterion is reached (G′=105 Pa) is determined. This temperature is denoted Tₚ of cohesion.

3. Finally, the level of the complex shear modulus G′ at room temperature (<50° C.) is determined, which accounts for the mechanical strength of the product.

Extrusion-Calendering:

The extrusion-calendering of the polymer granules was carried out on a Khune type K105 extrusion line, K60 co-extrusion with horizontal calenders, and Carraro die. Overall capacity 800 kg/h (only the extruder was used for the tests).

Once the temperature and speed parameters have been optimized, the compounds extrude and calender correctly and reproducibly. It is then possible to adjust the thickness of the film obtained. The thicknesses of the extruded films are close to 450 μm, maximum 500 μm.

Thermoforming New Mixtures and Forming Half-Balls:

To form the strips of half-spheres used in the filling-welding-cutting modules, a thermoforming machine is used.

The thermoformer is a prototype thermoformer equipped with:
two ovens, one lower and one upper oven, a negative mold with vacuum system,
a mechanical punching operating on the principle of the side clamp mounted on a spring,
continuous cutting by circular knives.

Finally, for forming, the modifiable parameters are the temperatures of the ovens and the heating time of the indexes.

For material distribution, it is possible to adjust the stroke of the punches and/or to use the suction delay time.

### Example 1 (not Forming Part of the Invention): Illustration of the Problems of Low Profitability and Degradation During the Storage of Paintballs Based on Oxodegradable Polymer

Balls containing aqueous formulations of microcapsules were manufactured according to the method described in FR3018268A1. The shell of these balls was made of oxodegradable polypropylene. At the end of production, these balls were stored in airtight aluminum bags, protected from light in a cold room (T°≈8° C.).

The percentage of good quality balls compared to the expected theoretical amount of balls was around 30.

Just after the end of production, ballistic tests were carried out on these balls, in particular to check the percentage of balls exploding in the barrel. A percentage of about 20% of balls exploding in the barrel was measured.

Two years later, the same ballistic test was carried out on a sample of 100 balls. 50% of these balls exploded in the barrel, showing a clear degradation of the mechanical properties of the oxo degradable polymer despite the precautions taken for storage. In addition, a large number of balls had lost their contents, which means that they were not completely sealed.

### Example 2: Choice of Materials for the New Biodegradable Polymer

The objective being to replace an oxodegradable polypropylene film, DMA rheological curves were performed, initially on the oxodegradable polypropylene used as a reference and then on the new biodegradable materials.

The DMA curve of oxodegradable polypropylene shows that this product has a cohesion point around 132° C. The complex shear modulus is around 20 MPa, the viscous plateau is around 3·10⁻² MPa.

It is therefore chosen to test, in a twin-screw extruder provided with a granulator, the following polymers in varying proportions:
High molecular weight polylactide (PLA)
Polybutylene co(Succinate/Adipate) (PBSA)
Polybutylene succinate (PBS)

In order to improve the miscibility of the polymers and to modulate the rigidity of the materials obtained, between 0 and 10% of mineral filler (talc) have been added to some of these compounds.

For some mixtures, combinations of release additives such as erucamides and bromamides have been used.

The rheological characteristics obtained are as follows:

TABLE 1

| | Outside | | | | | |
|---|---|---|---|---|---|---|
| No of new | inven- | | | | | |
| material | tion | 1 | 2 | 3 | 4 | 5 |
| Compound 2 | PP oxo | PLA | PLA | PLA | PLA | PLA |
| | | (10%) | (15%) | (15%) | (20%) | (50%) |
| Compound 1 | / | PBSA | PBSA | PBS | PBSA | PBS |
| | | (88%) | (82.5%) | (82.5%) | (77%) | (50%) |
| Mineral filler | / | Talc | Talc | Talc | Talc | Talc |
| | | (1%) | (1.5%) | (1.5%) | (2%) | (0%) |
| Tg of the | −5 | −45 | −45 | −32 | −32 | −45 |
| compound 1 | | | | | | |
| Tg of the | / | 63 | 63 | 63 | 63 | 63 |
| compound 2 | | | | | | |
| Rising Temp. | 132 | 63 | 63 | 98 | 63 | 93 |
| in cohesion | | | | | | |
| Complex | 40 | 20 | 30 | 10 | 80 | 35 |
| shear | | | | | | |
| modulus G* | | | | | | |
| (MPa) | | | | | | |
| Viscous | 20 | 20 | 10 | 30 | 20 | 2 |
| modulus after | | | | | | |
| decohesion | | | | | | |
| (140° C.) | | | | | | |
| (kPa) | | | | | | |

This table illustrates that the new materials according to the invention all have:
a glass transition temperature much less than 0° C. which gives a certain elastomedic character to the product even if the storage temperature is close to 0° C.
Their complex shear modulus G′ is greater than or equal to 10 MPa, which provides sufficient digidity to the ball to hold mechanically during storage and to fracture upon impact.

### Example 3: Example of Manufacturing the Hemispheres by Thermoforming for the New Material n^{o} 6

The material described above is used to thermoform material N^{o}5 containing 50% PLA and 50% PBS.

After extrusion-calendering, as described above, the widths obtained appear as strips with a width of 500 mm+/−5 and a thickness of 450μ. The material is flexible, smooth and slightly pearly white in color.

The thermoforming of the hemispheres is carried out on the thermoformer described previously.

The temperature settings (° C.) used are as follows:

TABLE 2

| | Lower | Upper | Lower | Upper | |
|---|---|---|---|---|---|
| | ovens | ovens | tool | tool | Ambient |
| Sample no5 | 175 | 175 | 33 | 35 | 26 |

The adjustment settings of the thermoformer are:

TABLE 3

| | Dwell time | Suction delay | Cycle time |
|---|---|---|---|
| | In sec | In msec | in sec |
| Sample no5 | 3 | 400 | 4.5 |
| Sample no5 | 3 | 200 | 4.5 |

### Example 4: Example of Adjustment of the Welding Modules to Control the Formation of Balls with the New Biodegradable Material n^{o} 5

After having thermoformed the hemispheres, they are filled with the formulation containing the selected active ingredient, then the welding and finally the cutting step are carried out according to the method described in the present invention.

For the new polymer n^{o} 5, the settings which lead to very good quality balls (non-leaky, with good ballistics) are as follows:

Table of Welding Parameters

TABLE 4

| Polymer | Energy | Force |
|---|---|---|
| Sample No5 | 120 joules | 19.63 daN |

### Example 5: Manufacture of Repellent Balls

This example illustrates the manufacture of paintballs containing a formulation whose active ingredient is alpha-pinene, known to the person skilled in the art as a repellent against certain insects (pine processionary for example).

A formulation containing 0.41% by weight of alpha-pinene is prepared as indicated above. Polymer mixture n^{o} 5 is used to form the shell of the balls.

From 139 kg of formulation based on alpha-pinene, balls are produced containing an average of 2.35 g of formulation each. The number of good quality balls obtained is 45656 compared to the theoretical number of targeted balls 59148. Therefore, a yield in relation to the pheromone of 77% is obtained compared to the yield of less than 50% obtained with the previous method (see example 1 not forming part of the invention). Moreover, ballistic tests with a paintball gun showed that no balls exploded in the barrel immediately after the production of said balls and that the ball trajectories were correct.

These balls were stored in sealed aluminum bags at T=8° C., after one year a new ballistic test was carried out with a paintball gun. Again, and contrary to the results obtained with the method of patent FR3018268A1, no ball exploded in the barrel.

### Example 6: Manufacture of Balls with Other Active Ingredients

A process identical to that according to Example 5 is used for the manufacture of ball-type projectiles containing the pine processionary pheromone, the codling moth pheromone, an insecticide pyretre and an insecticide spinosad, at concentrations in % by weight in the filling formulation of 4%, 4%, 0.6% and 0.6%, respectively.

The projectiles obtained are stable in storage, do not explode in the barrel and have much better ballistics, which allows for more accurate firing. The yields of the number of good quality balls compared to the number of theoretical balls obtained for these different production campaigns exceeded 90%.

1. A unit dose for storing, transporting, dispensing or releasing an aqueous formulation, wherein the unit dose comprises a shell containing the aqueous formulation, wherein the shell comprises a material comprising a mixture of two biodegradable polymers A and B, such that:
the biodegradable polymer A is a thermoplastic polymer having a glass transition temperature of less than 0° C. and
the biodegradable polymer B is a thermoplastic polymer having a glass transition temperature greater than 50° C.,
wherein the unit dose is spherically shaped comprising two poles and an equatorial area, wherein
the equatorial area corresponds to a weld of two hemispheres and
the shell has a line of circumferential weakness located between the equatorial area and one or both poles.

2. The unit dose according to claim 1, wherein:
the polymer A is selected from the group consisting in polycaprolactone, succinate polyesters and mixtures thereof; and
the polymer B is selected from the group consisting in polylactides.

3. The unit dose according to claim 2, wherein the succinate polyester is selected from the group consisting in polybutylene succinate, poly(butylene succinate), co-poly(butylene succinate adipate) and mixtures thereof.

4. The unit dose according to claim 1, wherein:
the amount of polymer A is comprised, in % by weight of the shell, between 50% and 95%, and
the amount of polymer B is comprised, in % by weight of the shell, between 5% and 50%.

5. The unit dose according to claim 1, wherein the Young's modulus of the shell material is greater than 5 MPa.

6. The unit dose according to claim 1, wherein the shell comprises a mineral filler in an amount comprised between 0% and 10% by weight of the shell.

7. The unit dose according to claim 1, wherein the line of circumferential weakness comprises a reduction in thickness of the shell.

8. The unit dose according to claim 7, wherein the reduction in thickness of the shell is such that the thickness of the shell is 20% to 60% of the thickness in the equatorial area and of 60% to 80% of the thickness at the poles.

9. The unit dose according to claim 1, wherein the aqueous formulation comprises an active ingredient selected from semiochemical compounds, insecticidal compounds, fungicidal compounds, odorous molecules and mixtures thereof.

10. The unit dose according to claim 9, wherein the semiochemical active ingredient is selected from insect and mammalian pheromones.

11-14. (canceled)

15. The unit dose according to claim 1, wherein the shell has two lines of circumferential weakness located between the equatorial area and one or both poles.

16. The unit dose according to claim 4, wherein:
the amount of polymer A is comprised, in % by weight of the shell, between 70% and 95%;
the amount of polymer B is comprised, in % by weight of the shell, between 5% and 20%.

17. The unit dose according to claim 4, wherein:
the amount of polymer A is comprised, in % by weight of the shell, between 60% and 95%;
the amount of polymer B is comprised, in % by weight of the shell, between 5% and 30%.

18. The unit dose according to claim 5, wherein the Young's modulus of the shell material is greater than 10 MPa.

19. The unit dose according to claim 5, wherein the Young's modulus of the shell material is greater than 20 MPa.

20. A method for protecting a plot against a pest comprising:
providing a unit dose according to claim 1, wherein the aqueous formulation comprises an active compound with regard to the pest, and
positioning the unit dose at a point of the plot in order to ensure diffusion of the active compound.

21. The method according to claim 20, wherein the diffusion of the active compound is achieved by the biodegradation of the shell of the unit dose.

22. The method according to claim 20, wherein the diffusion of the active compound is carried out by making an opening of the shell of the unit dose simultaneously or prior to its positioning.

23. The method according to claim 20, wherein the diffusion of the active compound is carried out by the projection of the unit dose on a solid support in order to ensure rupture of the shell of the unit dose.
